(19) United States
(12) Patent Application Publication
(10) Pub. No.: US 2015/0213490 A1
(43) Pub. Date: Jul. 30, 2015

(54) Methods And Apparatus for Targeted Advertising During Communication Through Communication Provider

(71) Applicant: Artases OIKONOMIDIS, Moscow (RU)

(72) Inventor: Artases OIKONOMIDIS, Moscow (RU)

(21) Appl. No.: 14/166,851

(22) Filed: Jan. 28, 2014

(51) Int. Cl. G06Q 30/02; H04L 29/08

(52) U.S. Cl. CPC G06Q 30/0251; H04L 67/14; G06Q 30/0267

(57) ABSTRACT

Methods, apparatus and computer-readable medium for providing advertising content by a communication network entity. A rendering characteristic associated with a communication device can be obtained and an electronic media advert formatted based on the obtained rendering characteristic. The formatted electronic media advert can then be transmitted to the communication device. The electronic media advert can be selected based on obtained subscriber information of the callers and the selected electronic media advert transmitted to a communication device of one or both of the subscribers.

A portion of the disclosure of this patent document contains material that is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### CROSS REFERENCE TO RELATED APPLICATIONS

N/A

### STATEMENT REGARDING FEDERAL RIGHTS

N/A

### TECHNICAL FIELD

Embodiments relate to methods for providing advertising content by electronic devices. Embodiments also relate to methods for providing advertising content by communication network entities. Embodiments further relate to apparatus for performing such methods. Embodiments yet further relate to computer-readable mediums including contents that are configured to cause computing systems to provide advertising content.

### BACKGROUND

Communication devices and advertising are both critical elements of society in the modern world. Efficient communication both advances civilization and understand, as well as vital for the advancement of science.

Advertisement both allows companies to increase their market and reduce cost, and allow mass communication to be subsidized, and therefore less expensive and available to a larger market. Therefore, the combination of introducing advertising to communication advances civilization and science.

Advertising is a means to generate revenue for the communication provider can be used to substitute, or in addition to fees charged to the customers for the communication service. Advertising informs the consumers about the brands available in the market and the variety of products they could find useful. Today, advertising must find new ways into a wide and complex type of communication methods.

In order to increase profits and/or reduce costs companies providing communication methods to consumers have looked to selling advertising content delivered in association with the communication methods. Both efficiency in delivery of advertising content, and targeting advertising content are critical in the effectiveness of the advertisement.

Targeting of advertising content can best be achieved by understanding each consumer's individual background demographics, including name, age, location, income, habits, and preferences. By allowing advertisers to focus their advertisements to these specific demographics, the advertisement will become more effective, and thus allow the communication provider to charge higher rates to the advertisers.

Further on advancing the targeting of advertisement, it is possible to find similarity in the demographic data of the users on each end of the communication, and focus advertising content on the similar data between the two users. For example, if it is known that both users live near one another, and both users have a preference to jazz music, an advertisement for a nearby jazz music concert might be well received during the communication between the two users with similar geographic locations and music preferences.

The comparing of demographic information may extend to comparing multiple profiles during a three-way or multi-party conference call. If it is known that all users are geographically located in vastly different areas and using different devices for the communication, but the majority of users are on Apple brand products such as iPhones or MacBooks, an advertisement for Apple brand products may be better received by the parties of the communication than an advertisement for a local restaurant or shop.

Targeting advertisement by accessing data from the profile of the person the subscriber calls rather than the subscribers own data may provide additional opportunity to target advertisement. For example, if the subscriber repeatedly contacts other subscribers in a specific geographic area that the subscribers own profile does not include, and the other subscribers receiving the communication all are fans of a sports team associated with the geographic area that the calling subscriber is not a part of, the calling subscriber may be receptive to advertisements related to the sports team in the area of the people they are contacting.

Targeting advertisement during communication may be further aided by using one users profile to deliver content to the other user. For example, if a man calls a woman, the man's preference for “flowers and chocolate” may not be in the mans profile. However, if the woman has information in her profile that indicates she likes “flowers and chocolate,” an advertisement could be sent to the man suggesting to “send her flowers and chocolate.”

Demographic information of a communication subscriber is not static information. Communication subscribers are now mobile, communicating to one another with their mobile phones and laptop computers from multiple locations. Communication subscribers may have a pattern of attending several music concerts for summer months, but then changing their habits to dining in local restaurants during winter months, and targeting advertisements for restaurants rather than music concerts may become more effective. Or it could be possible that the user has changed his habits to initiate communications late at night rather than during the day time, and targeting advertisements for establishments that are open late at night may become more effective. Therefore, by allowing the subscriber profile to continually be updated with new information, advertising content may become more effective.

Turning to the delivery of advertising content, communication providers have been challenged by the growing number of devices used for communication. Two users may be communicating to one another using different devices, where one may be on a mobile phone, and the other being on a personal computer. To best deliver advertising content to users on both sides of the communication, the advertisement may need to be formatted in entirely different ways.

### SUMMARY

According to one aspect, there is provided a method for providing advertising content by a communication network entity. The method can comprise obtaining a rendering characteristic associated with a communication device; formatting an electronic media advert based on the obtained rendering characteristic; and transmitting, by the communication network entity, the formatted electronic media advert to the communication device.

In one example, the method further comprises causing the formatted electronic media advert to be displayed on said communication device in response to a communication session being initiated, ongoing, and/or ending between said communication device and another communication device. The communication session can comprises at least one of a video call, text messaging, or voice call.

In one embodiment, the method further comprises in response to initiation of said communication session causing the formatted electronic media advert to be displayed on said communication device in place of or in conjunction with at least a portion of a communication session user interface for managing the communication session on the communication device. The method can further comprise in response to establishing said communication session, causing said formatted electronic advert to be substantially hidden or removed from display.

In one example obtaining a rendering characteristic associated with a communication device comprises obtaining a rendering characteristic based on at least one of model device “type” and screen size. In another example, obtaining a rendering characteristic comprises receiving a user selection of at least one of size, resolution, type; and selecting a rendering characteristic corresponding to said user selection.

In one embodiment, the method can further comprise converting said electronic media advert based on a user selection. For example, converting said electronic media advert based on a user selection can comprise converting said electronic media advert between one media type and another media type. The one media type can comprise audio media and said another media type comprises visual media.

In one example, the method can further comprise integrating said electronic media advert in at least one of a voice call user interface, video call user interface, SMS user interface of the communication device.

In one embodiment can further comprise receiving a communication attempt from a first communication device of a first subscriber to at least a second communication device of a second subscriber; obtaining first subscriber information relating to the first subscriber and second subscriber information related to the second subscriber; selecting said electronic media advert based on the obtained first and second subscriber information; wherein obtaining a rendering characteristic associated with a communication device comprises obtaining a rendering characteristic associated with at least one of said first and second communication devices; and wherein transmitting, by the communication network entity, the formatted electronic media advert to the communication device comprises transmitting, by the communication network entity, the selected electronic media advert to said at least one of the first and second communication devices.

According to one aspect, a method for providing advertising content by a communication network entity can comprise receiving a communication attempt from a communication device of a first subscriber to at least a communication device of a second subscriber; obtaining first subscriber information relating to the first subscriber and second subscriber information related to the second subscriber; selecting an electronic media advert based on the obtained first and second subscriber information; and transmitting, by the communication network entity, the selected electronic media advert to at least one of the first and second communication devices.

The method can further comprise obtaining a rendering characteristic associated with said at least one of the first and second communication devices; formatting an electronic media advert based on the obtained rendering characteristic; and wherein transmitting, by the communication network entity, the selected electronic media advert to at least one of the first and second communication devices comprises transmitting, by the communication network entity, the formatted electronic media advert to said at least one of the first and second communication devices. In one example, the first subscriber information comprises at least one of a first profile and first telephone number, and wherein said second subscriber information comprises at least one of a second profile and second telephone number.

In one embodiment, the method further comprises determining similar/same/matching subscriber information between said subscriber profile information among two or more subscriber profiles, and selecting the electronic media advert based on the determined similar/same/matching subscriber information.

In one or more embodiments, said communication attempt comprises at least one of a SMS communication attempt, a video call communication attempt, a voice call communication attempt, and a chat messaging communication attempt.

In one approach, advertising occurs by presenting an advertisement prior to, during, or after an audio call, video call, text message, or chat. The advertisement may be displayed to both the subscriber initiating the communication as well as the subscriber receiving the communication. Advertising may include interactive features to such as the ability to dismiss the advertisement, postpone the advertisement, or allow the subscriber to provide feedback as to if the advertisement was relevant to them. Advertising may be targeted to a subscribers individual demographic information.

According to yet another aspect, there is a provided an interactive feature contained within or near the advertisement content used both to acquire demographic data about the communication subscriber, and to allow the subscriber to see said advertising content later by an interaction, share said advertising content with another subscriber by an interaction, postpone viewing of said advertising content by an interaction, remove said advertising content by an interaction, like said advertising content by an interaction, like said advertising content by an interaction, retrieve more information related to said advertising content, purchase a product, access and save a mobile coupon or make a reservation for a restaurant or other venue.

According to yet another aspect, there is provided a subscriber profile contained within a subscriber database. The subscriber profile may contain present or past subscriber interactions with interactive feature, present or past geographic location information which the subscriber communication, present or past devices used by said subscriber communications, present or past time of day communication was initiated, present or past external information imported from the subscriber device such as web browser history or other data contained on the device, present or past use of key terms used during subscriber communication, present or past use of subscriber devices.

According to yet another aspect, there is provided a method for updating information contained within the subscriber profile based on subscriber interactions with the interactive feature, changes in subscribers device used, changes in calling times or frequency of key terms used in conversations.

According to yet another aspect, there is provided a database of advertising content with associated tags to indicate situations in which the advertising content may match information from the subscriber profile, and then be used in selection of advertising content to be delivered to the subscriber.

According to yet another aspect, communication events are monitored. Such communication events may include recognition of a key word, term, or phrase used during the communication, the initiation of the communication, the receiving of the communication, or the ending of the communication. Communication events may be used to bring about, or trigger, the delivery of advertising content. Additionally, communication events may be used to provide additional information for the user profile contained in the user database, such as frequency of key terms used by the subscriber, length of communications made by the subscriber, and time communications were initiated by the subscriber.

According to yet another aspect, electronic media adverts may be formatted for different device types, UIs, and call types (SMS, voice, chat, or video). Further, a user may have a formatting preference, such as resolution. For example, a blind person may have access to imaged-based text adverts by selecting that adverts be rendered only in audio (i.e., a text-to-speech application). Thus, a single set of adverts (e.g., high-resolution images) may be formatted into a number of different ways so to be compatible with different device types, UIs, call types, and/or user preferences.

Network providers may also dictate how adverts are dictated based on, for example, network activity (e.g., lower-resolution during peak activity). Advertisers may also have preferences or simply provide, for example, the highest-resolution image being the “preferred” format.

Similar formatting rules may apply to the interaction of the advert with a UI or video window (e.g., overlaid, embedded). For example, an image may be 100 percent transparent or opaque vis-à-vis a UI or video window.

According to yet another apparatus for providing advertising content, the apparatus can comprise: at least one processor operably connectable to at least one communication device; a data bus coupled to said at least one processor; a computer-usable medium embodying computer program code, said computer usable medium being coupled to said data bus; and said computer program code comprising instructions executable by said processor and configured for: obtaining a rendering characteristic associated with at least one communication device; formatting an electronic media advert based on the obtained rendering characteristic; and transmitting, by the communication network entity, the formatted electronic media advert to the at least one communication device. The computer program code can comprise additional instructions executable by said processor and configured for performing one or more methods of any of the aforementioned examples or embodiments.

A computer-readable medium including contents that are configured to cause a computing system to provide advertising content by performing a method comprising: obtaining a rendering characteristic associated with at least one communication device; formatting an electronic media advert based on the obtained rendering characteristic; and transmitting, by the communication network entity, the formatted electronic media advert to the at least one communication device.

According to yet another apparatus for providing advertising content, the apparatus can comprise: at least one processor operably connectable to at least one communication device; a data bus coupled to said at least one processor; a computer-usable medium embodying computer program code, said computer usable medium being coupled to said data bus; and said computer program code comprising instructions executable by said processor and configured for performing a method according to any one ore more of the aforementioned examples of embodiments.

According to yet another aspect, computer-readable medium including contents that are configured to cause a computing system to provide advertising content by performing a method according to any one or more of the aforementioned examples or embodiments.

### DESCRIPTION OF THE DRAWINGS

FIG. 1 is a schematic depicting an advertising system for providing advertising content by a communication network entity according to one embodiment;

FIG. 2 is a flow chart of method for providing advertising content by a communication network entity according to one embodiment;

FIG. 3A is a block diagram of an exemplary server;

FIG. 3B is a block diagram of an exemplary architecture of a mobile radio communication device for use with embodiments;

FIG. 4 is a schematic depicting an advertising system for providing advertising content by a service provider communication entity according to one embodiment;

FIGS. 5-7 are schematics respectively depicting advertising systems for providing advertising content according to alternative examples;

FIGS. 8-10 are respective exemplary screen shots of a communication device shown in FIG. 4 at different stages of call initiation according one embodiment.

### DETAILED DESCRIPTION OF THE PREFERRED EMBODIMENTS

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

A device used for text, audio or video communication having a screen may be used as a platform for advertising.

Advertisement data is stored in database. The database is accessed by the telecommunication provider when communication is initiated by a subscriber. When a subscriber initiates the communication through the service provider, the service provider connects with the advertisement database to retrieve an advertisement. The service provider then sends signal/data packet containing the advertisement along with or instead of usual information such as a “calling” icon to the subscriber initiating the communication.

Additionally, an advertisement may be provided to the subscriber being contacted along with the notification of the incoming communication.

Advertisement may further include interactive screen features. For example, a smartphone user may control presentation of ad by interacting with a “show later” or “close add” icon, or the subscriber may provide feedback such as “I like this add” “I don't like this add.”

In response to detecting call connection has been established, advertisement is automatically removed from screen and 1st subscriber (and/or 2nd subscriber) is presented with usual screen details for ongoing call.

In response to detecting call connection ended, advertisement may automatically reappear on screen (for example, if “show me later”) is previously selected.

Reference will now be made to the drawings in which the various elements of embodiments will be given numerical designations and in which embodiments will be discussed so as to enable one skilled in the art to make and use the invention.

Specific reference to components, process steps, and other elements are not intended to be limiting. Further, it is understood that like parts bear the same reference numerals, when referring to alternate Figures. It will be further noted that the Figures are schematic and provided for guidance to the skilled reader and are not necessarily drawn to scale. Rather, the various drawing scales, aspect ratios, and numbers of components shown in the Figures may be purposely distorted to make certain features or relationships easier to understand.

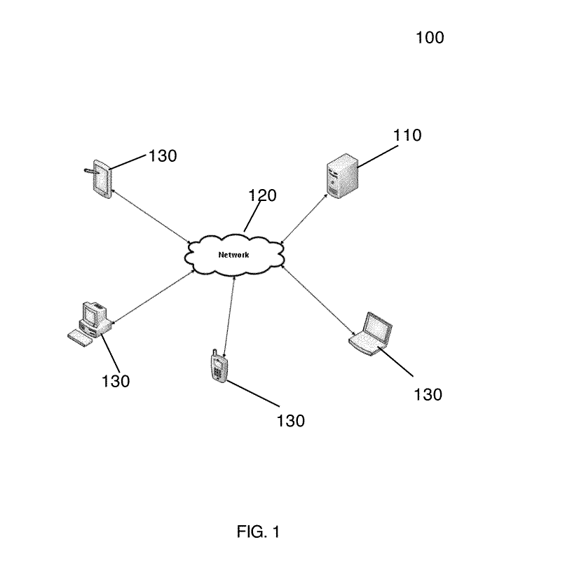

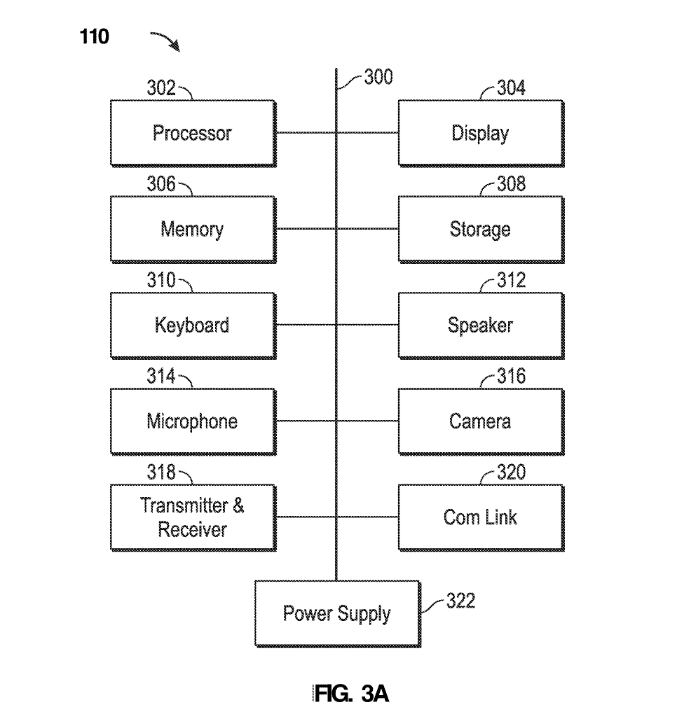

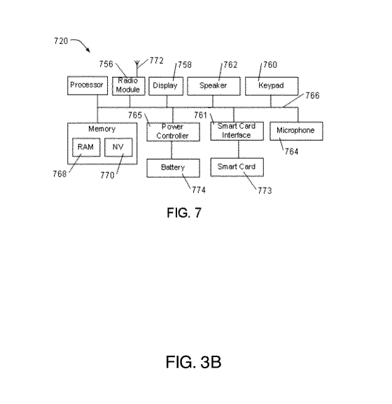

With reference to FIG. 1, an embodiment of a mobile advertising system 100 is presented. The system 100 includes an advert server 110 that is in operable communication with a data network 120. Data network 120 may encompass any suitable data network, such as, without limitation, a wireless (e.g., cellular or “WiFi”) communication network supporting any suitable data transmission protocol including without limitation LTE, CDMA, TDMA, GSM, TCP/IP, 802.11 WiFi, and the like. One or more user devices 130 are operably coupled to the data network 120. User devices 130 may include any suitable mobile device adapted for mobile communication as described, for example in FIG. 3B. User devices may also include without limitation a workstation, personal computer, notebook computer, tablet computer, and so forth. User devices 130 are in operable communication with data network 100 and may include executable software adapted to communicate with advert server 110 and/or one or more user devices 130. In some embodiments, advert server 110 is configured to choose and/or format adverts that are transmitted to user devices 130. For example, advert server 110 or another network entity may format an advert based on a detected device type, user preference, or user device operation system.

FIG. 3A illustrates in block diagram the major components of an exemplary computing device embodying advertisement server 110 according to one embodiment. Bus 300 interconnects various functional components that combine to provide the functionality of a computing device. Processor 302 executes instructions loaded into memory 306 from storage 308. Display 304 is typically a screen upon which visual items are displayed to a user, such as text, video, photographs, and the like. Display 304 can also include a touch screen, and serve as an input device as well as a display. Memory 306 typically holds a file temporarily until it is either deleted, or stored in storage 308 or sent to another computing device. Keyboard 310 allows a user to type alphanumeric input to processor 302, but pointing devices such as a mouse or touch pad can also be utilized. Speaker 312 functions to provide an audio output to a user, such as music, ambient sound recorded at an event, audio overlays in which a human provides a spoken description of a file, and the like. Such audio can also be recorded by microphone 314 and placed in memory 306 and/or storage 308. Camera 316 may be included to capture video and photographs, which are placed in memory 306 or storage 308. Connection to a network, such as the computer network or telecommunications network can be via radio, utilizing transmitter and receiver module 318 and an associated antenna, or through a wired connection managed by communication link 320. Finally, power supply 322 can be either a battery, in the case of portable computing devices, or an alternating current supply such as used to power a stationary computing device such as a desktop computer or server farm.

FIG. 3B shows a block diagram of an example architecture of mobile radio communication terminal device 720 (in this example, a mobile radio telephone), for use with embodiments. Mobile communication device 720 may include processor 752, memory 754, radio module 756, display 758, keypad 760, smart card interface 761, speaker 762, microphone 764, and power controller 765, all connected by bus 766. In some embodiments, memory 754 may include random access memory 768, such as conventional DRAM, and non-volatile memory 770, such as conventional flash memory, for storing the firmware that operates mobile communication device 720, as well as other parameters and settings that should be retained by mobile communication device 720. Radio module 756 may include antenna 772, and may be used to communicate wirelessly with a femtocell. In some embodiments, radio module 756 is a transceiver.

Smart card interface 761 may be used to connect smart card 773 to mobile radio communication terminal device 720. Examples of such smart cards include SIM (Subscriber Identity Module) cards, UICC (Universal Integrated Circuit Card) smart cards with integrated SIM or USIM (Universal Subscriber Identity Module), or other types of smart cards.

Mobile radio communication terminal device 720 may be housed in a compact portable housing (not shown). For purposes of mobility, mobile radio communication terminal device 720 would typically be powered by battery 774 connected to power controller 765.

It will be understood that the architecture shown in FIG. 3B is only one possible architecture for mobile radio communication terminal device 720, and that there may be many variations or additions to the architecture. For example, speaker 762 and microphone 764 may be part of a more complex sound module, display 758 may be a touch-screen, obviating the need for the keypad 760, and/or additional I/O devices, such as a wireless personal area network interface (e.g., a BLUETOOTH wireless network interface) may be added to mobile communication device 720.

Computer networking system environments and communication network entities for implementing the advertising system may vary according to the type of communication system providing communication sessions between the communication devices.

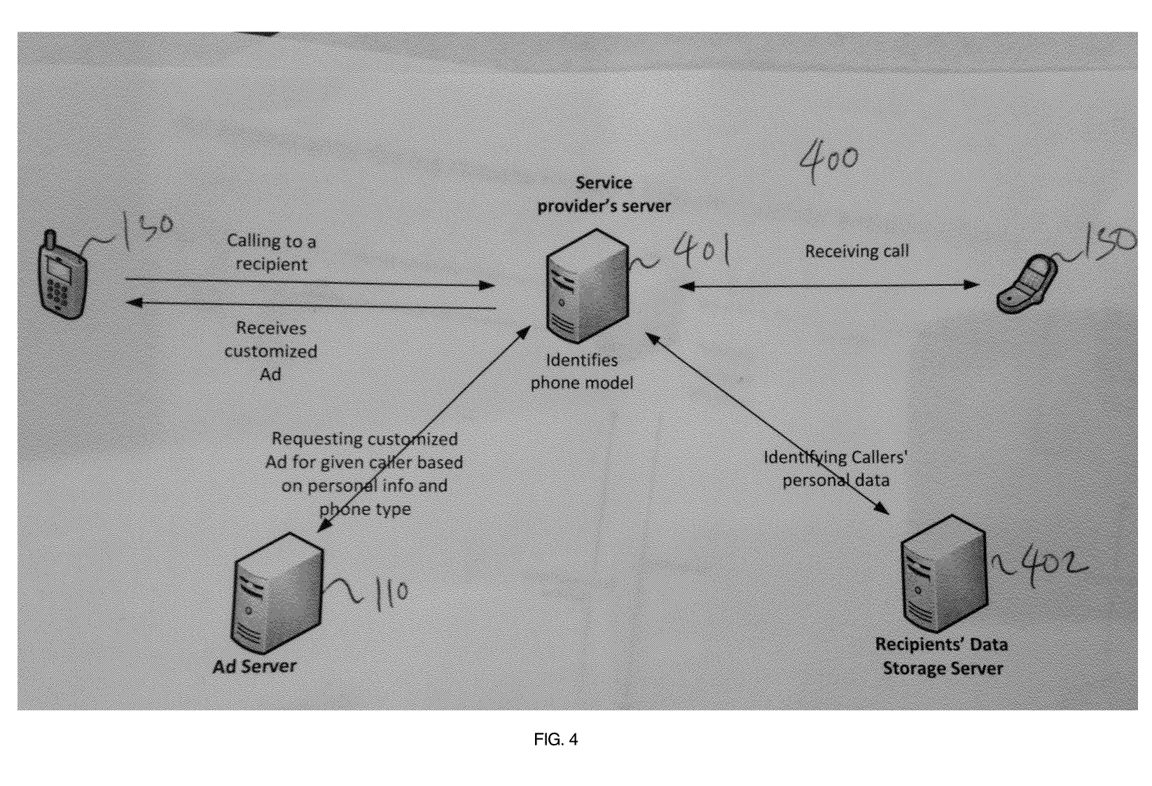

By way of example, in one embodiment, the advertising system 400 is arranged for use with a telecommunications system which provides communication sessions between smartphones or other communication devices. The advertising system includes advert server 110, telecommunication service provider server 401, recipient data storage server 402 as illustrated in the schematic of FIG. 4. Service provider server 401 is configured to provide telecommunication services to user devices 130. Service provider server may for example be a computer device as shown in FIG. 3 or another type of computer device. Service provider server 401 is further configured to identify the models/types of phones or other user devices 130 that are attempting to communicate with one another and to retrieve personal data of subscriber users associated with the user devices. Service provider server 401 and ad server 110 are configured to intercommunicate over one or more networks, such as network 120. Ad advert server is configured to provide advertisements customized according to a given caller's personal info and phone model/type. Service provider server 401 and recipient's data storage server 402 are configured to communicate over one or more networks, such as network 120. Recipient's data storage server 402 includes a file or other data storage system containing personal data of user callers capable of making and receiving calls using mobile phones or other user devices 130. Recipient's data storage server may for example be a computing device as shown in FIG. 3 or another type of computing device.

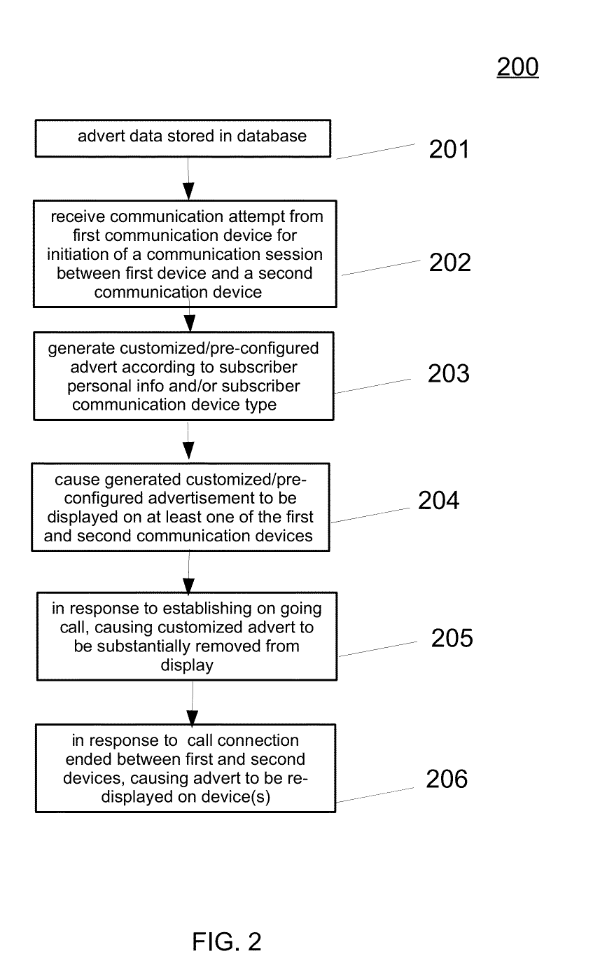

Examples of methods for providing advertising content by a communication network entity will now be described. A method 200 for providing advertising content by a communication network entity according to one embodiment is depicted in flow chart form in FIG. 2. Method 200 may be implemented in different advertising systems such as for example depicted in FIGS. 4-7. Let us assume a scenario in which a communication session is to be established between a first communication device of a 1^{st} subscriber and a second communication device of a second subscriber, the communication devices being smartphones.

In process 201, advertisement data is pre-stored in a database. Ad data is stored in database accessible by a server of a telecommunication provider (e.g. txt, cellular or internet telecommunication provider). By way of example in the communication system shown in FIG. 4, the database is stored on ad server 110.

In process 202, a communication attempt for initiation of a communication session from the first communication device of the first subscriber to the communication device of the second subscriber is received. In the example of FIG. 4, the communication session is a telephone call. In other examples, the communication session may be a video call communication session, chat/text messaging communication session or any combination of video, voice, chat, text messaging. In the example of FIG. 4, the communication attempt is in the form of an outgoing call signal that is received by the server of the provider (telecom, internet or other provide using a system like GSM, LTE, GPRS, Satellite, VOIP or other) for connecting 1^{st} subscriber to device with number of 2^{nd} subscriber.

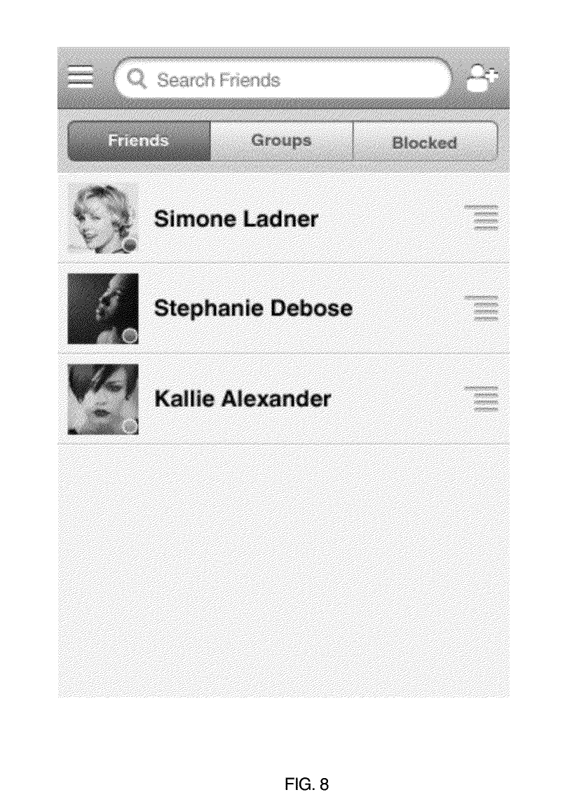

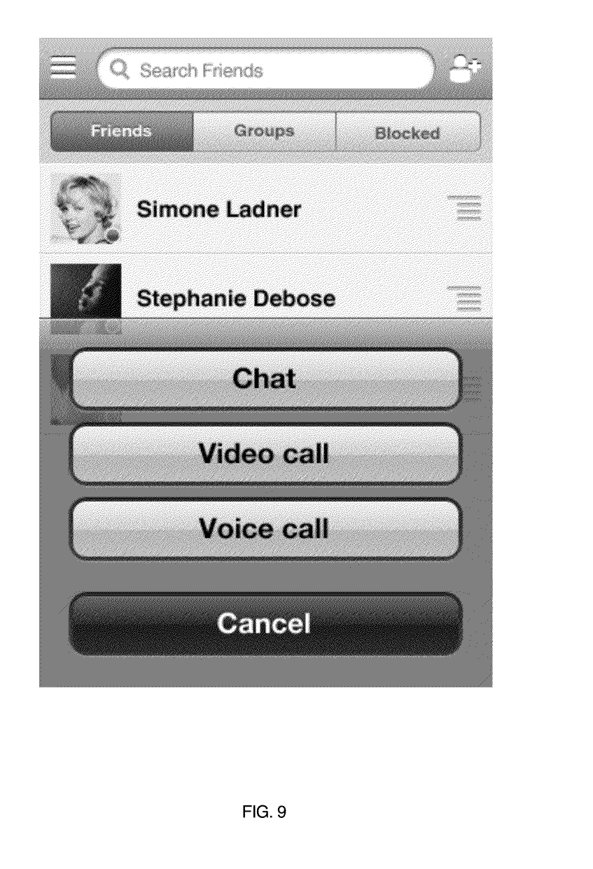

A communication session user interface is displayed on the communication devices to enable the users to manage the communication session between the first communication device and second communication device. One non-limiting example of such a communication session interface is depicted in FIGS. 8 & 9. As shown in FIG. 8, the user interfaces displays contact information for selection to the user (FIG. 8) and in response to a user selection displays different communication session options to the user for selection, such as video call, voice call, chat/messaging (see FIG. 9). For example, receiving a user entered selection of voice call causes the smartphone in FIG. 4 to generate the outgoing call signal for receiving by the server. In one example, the communication session user interface displayed on the first communication device may be the same type of user interface as displayed on the second communication device. In another example, the communication session user interface displayed on the first communication device is different form the communication session user interface displayed on the second communication device.

In process 203, an advertisement is provided according to subscriber personal info and/or model/type associated with the first communication device. To this end, first subscriber information relating to the first subscriber and/or second subscriber information related to the second subscriber is obtained. In the system of FIG. 4, this information is obtained by the service provider accessing the recipient storage server or other databases containing subscriber personal information. The server may also obtain model/type information of the communication devices. An electronic media advert is selected based on the obtained first and/or second subscriber information. In the system of FIG. 4, the advert is selected by the advert server according to the information received from the server. In another embodiment, an advertisement is alternatively or additionally provided according to subscriber personal info and/or model/type associated with the second communication device.

In one embodiment, the selected advert is a pre-configured advert that is selected according to the obtained information. In another embodiment, alternatively or additionally, the selected advert is an advert that has been customized according to the obtained information. The content of the advert and/or the format of the advert may be pre-configured and/or customized according to the obtained information. In one example, the advert is selected and/or customized according to obtained personal data of the user. In another example, the advert is selected and/or customized according to obtained model/type information for the communication device of the user. In other examples, adverts are selected and/or customized according to both obtained personal data of the user and/or model/type of the communication device of the user.

In one embodiment, the electronic media advert is formatted according to a rendering characteristic such as but not limited to advert display size, resolution/media type (audio, visual). In one example, the rendering characteristic is determined according to the personal data and/or model/type information for the communication device. In one example, a rendering characteristic is obtained is associated with the communication device. In one example, the rendering characteristic is user defined. For example, the rendering characteristic can be determined by the server in response to receiving a user selection entered via the communication device of at least one of size, resolution, and media type of advert.

In process 204, the communication network entity causes the generated advertisement to display on at least one of the first and second communication devices. In the system of FIG. 4, the server is the communication entity that causes the advert to be displayed by sending signal/data packet sent from server to 1^{st} subscriber smartphone. Signal/data packet includes the generated advertisement for rendering on smartphone. In response to receiving outgoing signal, signal/data packet sent from server to 1^{st} subscriber smartphone, the smartphone displays the generated advertisement on the screen of the smartphone.

In one embodiment, the advert is selected by the advert server according to the personal info of the second subscriber being called the first subscriber and the server causes the selected advert to be displayed on the first subscriber's device. Displaying on the first subscriber's device an advert selected according to information about the second subscriber being called by the first subscriber's device has several benefits. For example, information about a provider of goods and services can be stored on the recipient's data storage and when a first subscriber initiates a call to the goods and services provider, an advert is selected based on the goods and services provider information (second subscriber) and sent to the first subscriber.

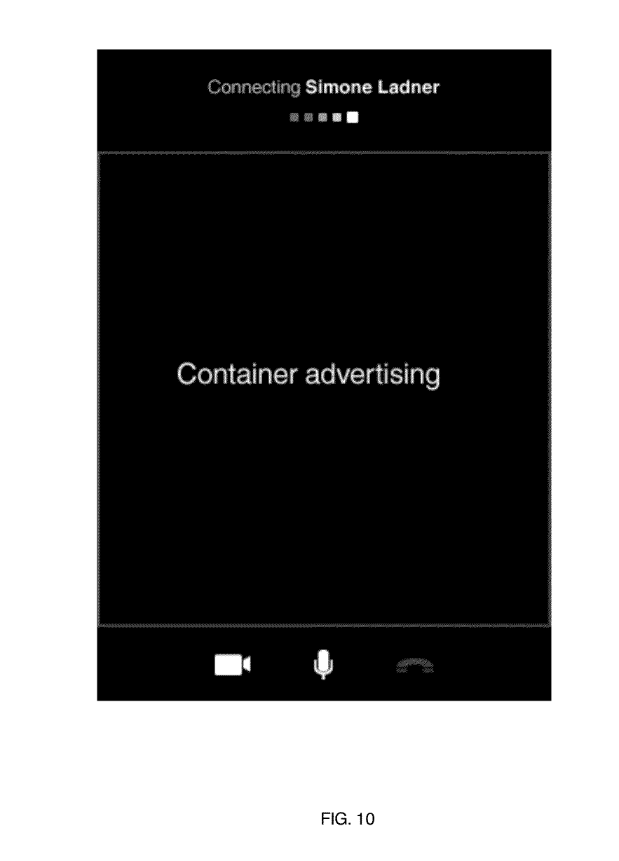

In one embodiment, the generated advertisement is displayed on the first communication device in place of the displayed communication session user interface. In another embodiment, the generated advertisement is displayed in conjunction with at least part of the communication session user interface. By way of example, the generated advertisement is displayed on the first communication device during the process of initiation of the call session in conjunction with a portion of the communication session user interface. For example, display of the communication session user interface shown in FIG. 9, changes to display the generated advertisement and the connecting status of the call (see FIG. 10 which depicts the container advertising portion of the screen where the generated advertisement is to be displayed whilst the communication session user interface continues to display above the advertisement container the “connecting” status and the “name” of the entity being called).

In process 205, the displayed advertisement is substantially removed from display in response to the ongoing call being established. For example, the advertisement can be removed and the communication session user interface can be re-displayed in full on the communication device In process 206, in response to the call connection between the first and second communication devices ending, the generated advertisement is re-displayed on the communication device. By way of example to advertising system of FIG. 4, the advertisement is provided the smartphone screen instead of, or in addition to, usual call info such as “calling” icon. Advertisement can be provided on 2^{nd} subscriber smartphone screen in same way by same server or another server managing call for 2^{nd} subscriber. Advertisement can include interactive screen features to enable smartphone user to control presentation of ad, such as “show later” “close add”, and also to provide feedback such as “I like this add” “I don't like this add”. In response to detecting call connection has been established, advertisement is automatically removed from screen and 1^{st} subscriber (and/or 2^{nd} subscriber) is presented with usual screen details for ongoing call. In response to detecting call connection ended, advertisement may automatically reappear on screen (for example, if “show me later”) is previously selected.

Processes 205 and 206, are just some examples. In another embodiment, display of the advertisement is maintained during the ongoing call. In yet another embodiment, the generated advertisement is re-displayed during and/or after the call in response to one or more user entered selections.

The above methodology can be implemented in other devices, e.g. tablet and pc that are capable of making internet or celluar calls (eg. ipad, PC skype etc.)

In some examples, the device making the call does not need to remove the advertisement, or the entire advertisement, in response to call connection being established. For example, the advertisement may continue to be rendered, if the screen has enough space to additionally show the usual call info without removing the ad. The ad can have different sizes depend on the model of mobile devices, and can have different button like—close add, see later, I like this add or don't like.

When people are using videophone, like Skype or other, the ad can be closed or can be on part of screen which is not being used during the connection, in the next connection can be another ad, depending on setting in the software of provider.

Computer networking system environments and communication network entities operating in those environments may vary according to the different methods for communicating between the communication devices.

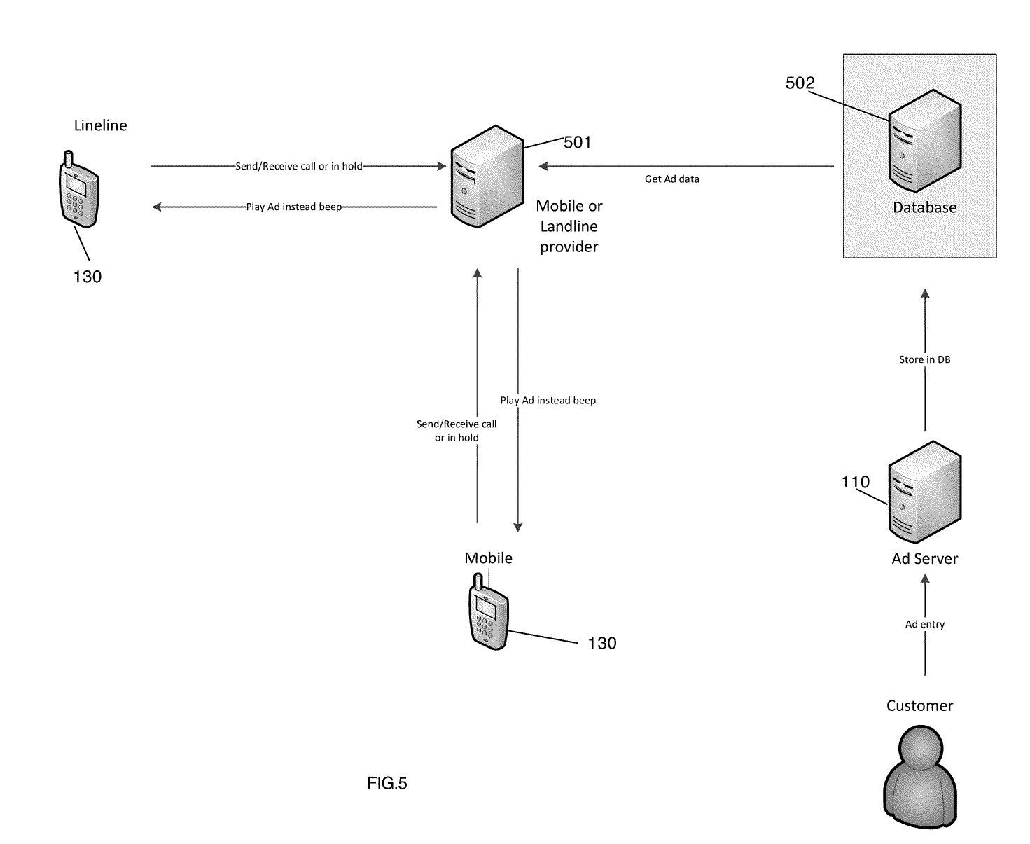

Other embodiments of the advertising systems are illustrated in schematics of FIGS. 5 to 7. FIG. 5 shows a schematic depicting a communication system 500 configured for providing advertising content during communication between a mobile user device and a landline client according to one embodiment. In this example, the service provider server is a mobile or landline service provider server 501 which is configured to provide communication phone services over the network between a landline phone device and a mobile phone device, to retrieve advert data from a database 502 and provide the adverts to the mobile phone and landline devices. Ad server 110 is configured to receive ad data entered by an ad provider user and store the ad data in database 502.

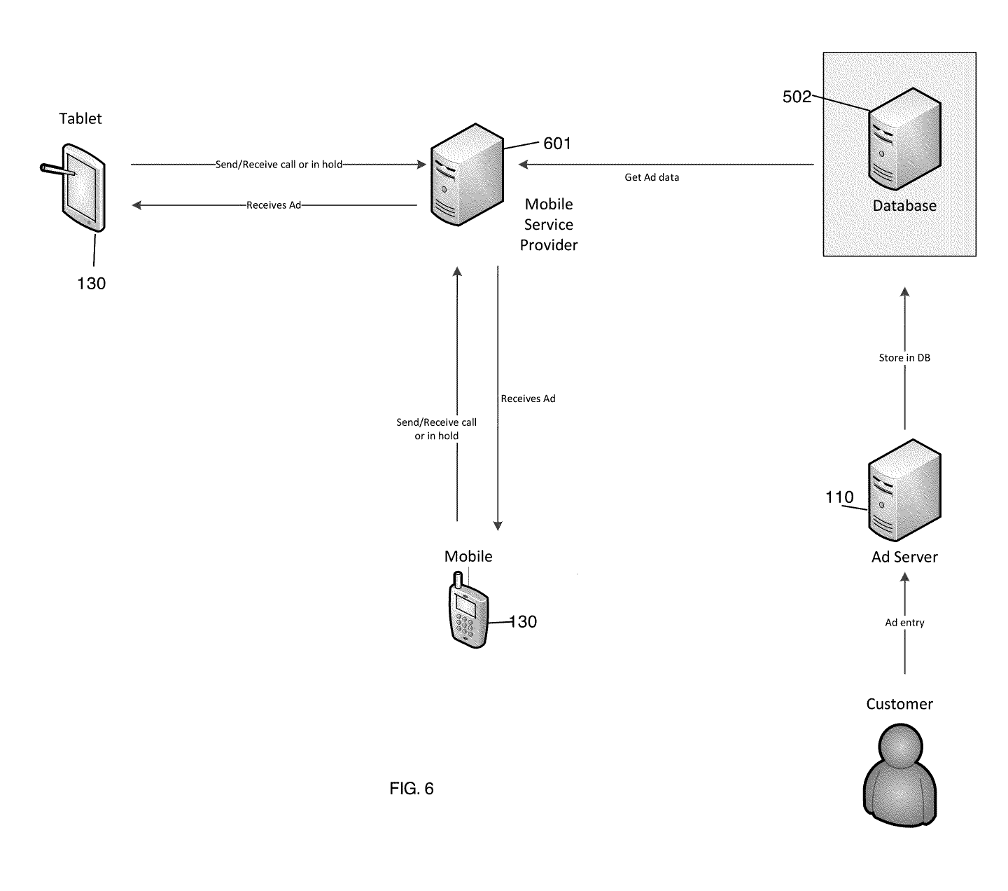

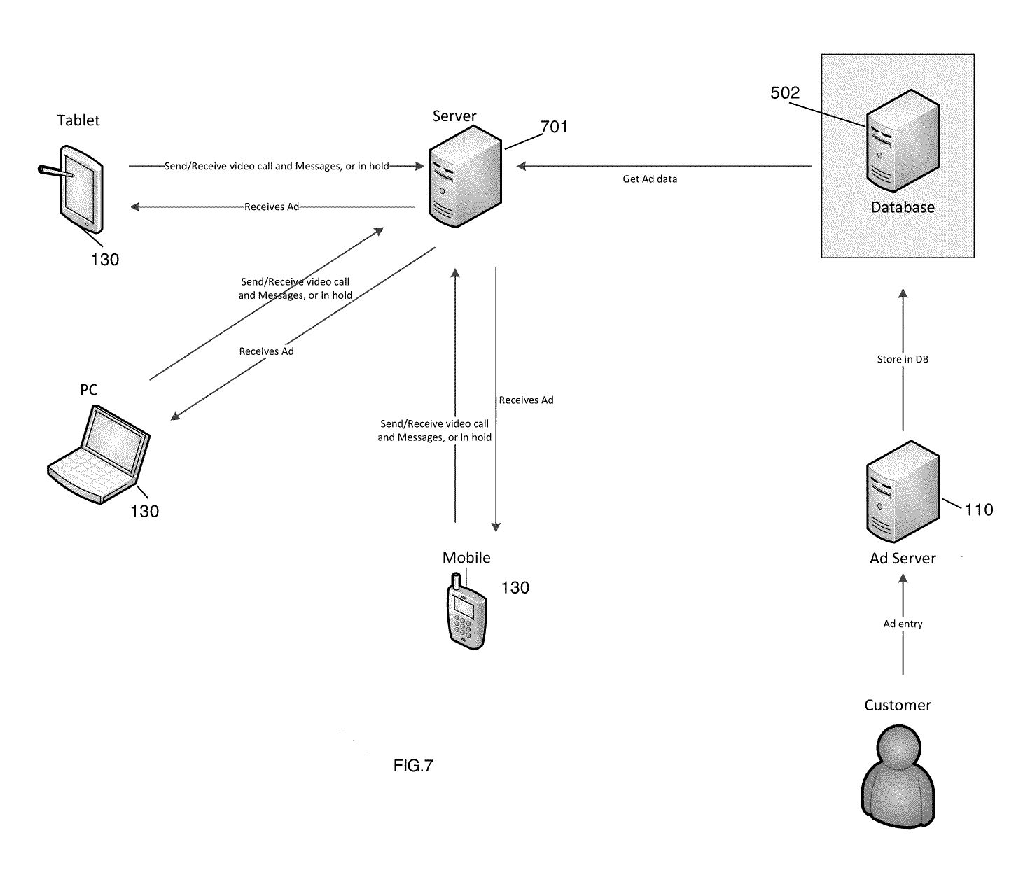

FIGS. 6 and 7 depict alternatives to the communication system of FIG. 5. In FIG. 6, communication system 600 has a mobile service provider server 601 and is configured for providing advertising content during communication between virtual network clients according to one embodiment. In FIG. 7, communication system 700 is configured for providing advertising content during video and/or message communication between virtual network clients according to one embodiment. System 700 has a video call/message server 701 configured to provide video call and/or messaging communication between user devices 130 and to retrieve and provide the customized advert data to the user devices. By way of example, a similar approach to above for providing advertising content in telephone communication is applied to text messaging e.g. sms and other text messaging and chat. In one embodiment, for chat communication, when the user opens the chat page and enters the first word, the software of the service automatically causes the server to send the special packet with the ad to the user device and the ad is displayed on the user device screen. The system can, in response to receiving user interface input on the user device, close it or push to see later, or like dislike or share.

It is to be understood that the described embodiments of the invention are illustrative only and that modifications thereof may occur to those skilled in the art. While the preferred embodiments of the invention have been illustrated and described, it will be clear that the invention is not so limited. Numerous modifications, changes, variations, substitutions, equivalents and interchangeable order of steps will occur to those skilled in the art without departing from the spirit and scope of the present invention as described; and set forth in the claims. Accordingly, this invention is not to be regarded as limited to the embodiments disclosed, but is to be limited only as defined by the appended claims herein.

What is claimed is:

1. A method for providing advertising content by a communication network entity, the method comprising:
obtaining a rendering characteristic associated with a communication device;
formatting an electronic media advert based on the obtained rendering characteristic; and
transmitting, by the communication network entity, the formatted electronic media advert to the communication device.

2. The method of claim 1, further comprising causing the formatted electronic media advert to be displayed on said communication device in response to a communication session being initiated, ongoing, and/or ending between said communication device and another communication device.

3. The method of claim 2, wherein said communication session comprises at least one of a video call, text messaging, or voice call.

4. The method of claim 3, further comprising in response to initiation of said communication session causing the formatted electronic media advert to be displayed on said communication device in place of or in conjunction with at least a portion of a communication session user interface for managing the communication session on the communication device.

5. The method of claim 3, further comprising in response to establishing said communication session, causing said formatted electronic advert to be substantially hidden or removed from display.

6. The method of claim 1, wherein obtaining a rendering characteristic associated with a communication device comprises obtaining a rendering characteristic based on at least one of model device “type” and screen size.

7. The method of claim, wherein obtaining a rendering characteristic comprises receiving a user selection of at least one of size, resolution, type; and selecting a rendering characteristic corresponding to said user selection.

8. The method of claim 7, further comprising converting said electronic media advert based on a user selection.

9. The method of claim 8, wherein converting said electronic media advert based on a user selection comprises converting said electronic media advert between one media type and another media type.

10. The method of claim 10, wherein said one media type comprises audio media and said another media type comprises visual media.

11. The method of claim 2 further comprising integrating said electronic media advert in at least one of a voice call user interface, video call user interface, SMS user interface of the communication device.

12. The method of claim 1 further comprising;
receiving a communication attempt from a first communication device of a first subscriber to at least a second communication device of a second subscriber;
obtaining first subscriber information relating to the first subscriber and second subscriber information related to the second subscriber;
selecting said electronic media advert based on the obtained first and second subscriber information;
wherein obtaining a rendering characteristic associated with a communication device comprises obtaining a rendering characteristic associated with at least one of said first and second communication devices; and
wherein transmitting, by the communication network entity, the formatted electronic media advert to the communication device comprises transmitting, by the communication network entity, the selected electronic media advert to said at least one of the first and second communication devices.

13. A method for providing advertising content by a communication network entity comprising:
receiving a communication attempt from a communication device of a first subscriber to at least a communication device of a second subscriber;
obtaining first subscriber information relating to the first subscriber and second subscriber information related to the second subscriber;
selecting an electronic media advert based on the obtained first and second subscriber information; and
transmitting, by the communication network entity, the selected electronic media advert to at least one of the first and second communication devices.

14. The method of claim 13 further comprising
obtaining a rendering characteristic associated with said at least one of the first and second communication devices;
formatting an electronic media advert based on the obtained rendering characteristic; and
wherein transmitting, by the communication network entity, the selected electronic media advert to at least one of the first and second communication devices comprises transmitting, by the communication network entity, the formatted electronic media advert to said at least one of the first and second communication devices.

15. The method of claim 14, wherein said first subscriber information comprises at least one of a first profile and first telephone number, and wherein said second subscriber information comprises at least one of a second profile and second telephone number.

16. The method of claim 15, further comprising determining similar/same/matching subscriber information between said subscriber profile information among two or more subscriber profiles, and selecting the electronic media advert based on the determined similar/same/matching subscriber information.

17. The method of claim 15, wherein said communication attempt comprises at least one of a SMS communication attempt, a video call communication attempt, a voice call communication attempt, and a chat messaging communication attempt.

18. An apparatus for providing advertising content, apparatus comprising:
at least one processor operably connectable to at least one communication device;
a data bus coupled to said at least one processor;
a computer-usable medium embodying computer program code, said computer usable medium being coupled to said data bus; and said computer program code comprising instructions executable by said processor and configured for:
obtaining a rendering characteristic associated with at least one communication device;
formatting an electronic media advert based on the obtained rendering characteristic; and
transmitting, by the communication network entity, the formatted electronic media advert to the at least one communication device.

19. The apparatus of claim 18, said computer program code comprising additional instructions executable by said processor and configured for:
causing the formatted electronic media advert to be displayed on said communication device in response to a communication session being initiated, ongoing, and/or ending between said communication device and another communication device.
